(19) United States
(12) Patent Application Publication
(10) Pub. No.: US 2007/0236564 A1
(43) Pub. Date: Oct. 11, 2007

(54) Color compensation system for images captured underwater

(75) Inventor: Mark Takita, Menlo Park, CA (US)

Correspondence Address: THE LAW OFFICE OF STEVEN G ROEDER, 5560 CHELSEA AVE, LA JOLLA, CA, 92037, US

(73) Assignee: NIKON Corporation

(21) Appl. No.: 11/399,106

(22) Filed: Apr. 6, 2006

(51) Int. Cl. H04N 7/18

(52) U.S. Cl. 348/81; 348/82

(57) ABSTRACT

A color compensation system (12) for providing an adjusted image (700) of a captured image (474) of a scene (15) that is within a fluid (16) includes compensation software (698). The compensation software (698) can adjust the captured image (474) utilizing information regarding at least one of a plurality of compensation factors that include (i) a clarity of the fluid (16), (ii) an apparatus depth of an image capturing apparatus (10), (iii) a separation distance between the image capturing apparatus (10) and a subject (20) of the scene (15), (iv) a fluid type of the fluid (16), (v) a subject depth of the subject (20), (vi) an approximate time of day the captured image (474) is captured, (vii) an approximate date the captured image (474) is captured, (viii) an approximate geographic location in which the captured image (474) is captured, (ix) an angle of incidence, and (x) an approximate weather condition in which the captured image (474) is captured. Further, the compensation software (698) can adjust the captured image (474) based on a color reference (482) positioned in the scene (15) and contained within the captured image (474) as a captured color reference image (782C).

### BACKGROUND

Cameras are commonly used to capture an image of a scene. Additionally, some cameras are waterproof and are used to capture an image of a scene that is underwater.

It is well known that water absorbs longer wavelength light more rapidly then shorter wavelength light. As a result, at shallow depths below water, red structures in the scene no longer appear red. This effect continues for increasing depths, and longer wavelength (visible) colors. As a result thereof, typical underwater photographs are dominated by short wavelength colors, e.g. blue and the longer wavelength colors, e.g. red are absorbed proportionally to the depth underwater.

### SUMMARY

The present invention is directed to a compensation system for adjusting a captured image of a scene that is within a fluid. The captured image is captured by an image capturing apparatus. The compensation system includes compensation software that adjusts the captured image to provide an adjusted image. In one embodiment, the compensation software utilizes information regarding at least one of a plurality of compensation factors that include (i) a clarity of the fluid, (ii) an apparatus depth of the image capturing apparatus, (iii) a separation distance between the image capturing apparatus and a subject of the scene, (iv) a fluid type of the fluid, (v) a subject depth of the subject, (vi) an approximate time of day the captured image is captured, (vii) an approximate date the captured image is captured, (viii) an approximate geographic location in which the captured image is captured, (ix) an angle of incidence, and (x) an approximate weather condition in which the captured image is captured.

For example, the compensation software utilizes the information regarding one or more of the plurality of compensation factors to calculate an attenuation of light, and the compensation software adjusts the color composition of the captured image based on the calculated attenuation of light for each different wavelength. With this design, the compensation program can compensate for the colors that are attenuated by the fluid. In one embodiment, the compensation software adjusts the captured image based on information regarding at least 2, 3, 4, 5, 6, 7, 8, 9, or all 10 of the compensation factors.

In one embodiment, the compensation system includes a system input device that allows a user to input information regarding one or more of the compensation factors. Further, the system input device can allow the user to adjust the information regarding one or more the compensation factors to achieve the desired color composition of the adjusted image.

The present invention is also directed to a combination comprising an image capturing apparatus and the compensation system. In one embodiment, the image capturing apparatus measures one or more of the compensation factors. Additionally, or alternatively, the image capturing apparatus can include a control switch that allows a user to input information regarding one or more of the compensation factors.

The present invention is also directed to compensation software that adjusts the captured image based on a color reference positioned in the scene and contained within the captured image as a captured color reference image. For example, if the color reference includes the color white and the compensation software adjusts the captured image so that an adjusted color reference image in the adjusted image includes the color white. Alternatively, the color reference can include at least one of the primary colors and the compensation software adjusts the captured image so that the adjusted color reference image in the adjusted image includes the primary color.

The present invention is also directed to a method for adjusting a captured image of a scene that is within a fluid. In one embodiment, the method includes the step of adjusting the captured image with a compensation software that adjusts the captured image based on information regarding at least one of the (i) a clarity of the fluid, (ii) an apparatus depth of the image capturing apparatus, (iii) a separation distance between the image capturing apparatus and a subject of the scene, (iv) a fluid type of the fluid, (v) a subject depth of the subject, (vi) an approximate time of day the captured image is captured, (vii) an approximate date the captured image is captured, (viii) an approximate geographic location in which the captured image is captured, (ix) an angle of incidence, and (x) an approximate weather condition in which the captured image is captured.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a simplified side plan illustration of a combination that includes an image capturing apparatus and a color compensation system having features of the present invention;

FIG. 1B is a simplified side plan illustration of a scene and an image capturing apparatus having features of the present invention;

FIG. 1C includes a graph that illustrates the attenuation of light as a function of wavelength and a graph that illustrates the percentage of light reaching certain depths;

FIG. 2A is a simplified front perspective view of one embodiment of the image capturing apparatus;

FIG. 2B is a simplified rear perspective view of the image capturing apparatus of FIG. 2A;

FIG. 3 is a simplified side plan illustration of another embodiment of an image capturing apparatus having features of the present invention;

FIG. 4A is a simplified top plan illustration of a scene and another embodiment of an image capturing apparatus;

FIG. 4B illustrates the rear view of the image capturing apparatus of FIG. 4A;

FIG. 4C illustrates one embodiment of a color reference having features of the present invention;

FIG. 4D illustrates another embodiment of a color reference having features of the present invention;

FIG. 5 illustrates a rear view of another embodiment of the image capturing apparatus;

FIG. 6 is a simplified illustration of the color compensation system;

FIG. 7A is a simplified illustration of a RGB histogram of a scene, a RGB histogram of an unadjusted captured image of the scene, and a RGB histogram of an adjusted captured image of the scene

FIG. 7B is a simplified illustration of a RGB histogram of another scene, a RGB histogram of an unadjusted captured image of the scene, and a RGB histogram of an adjusted captured image of the scene; and

FIG. 8 is a simplified illustration of another embodiment of the color compensation system.

### DESCRIPTION

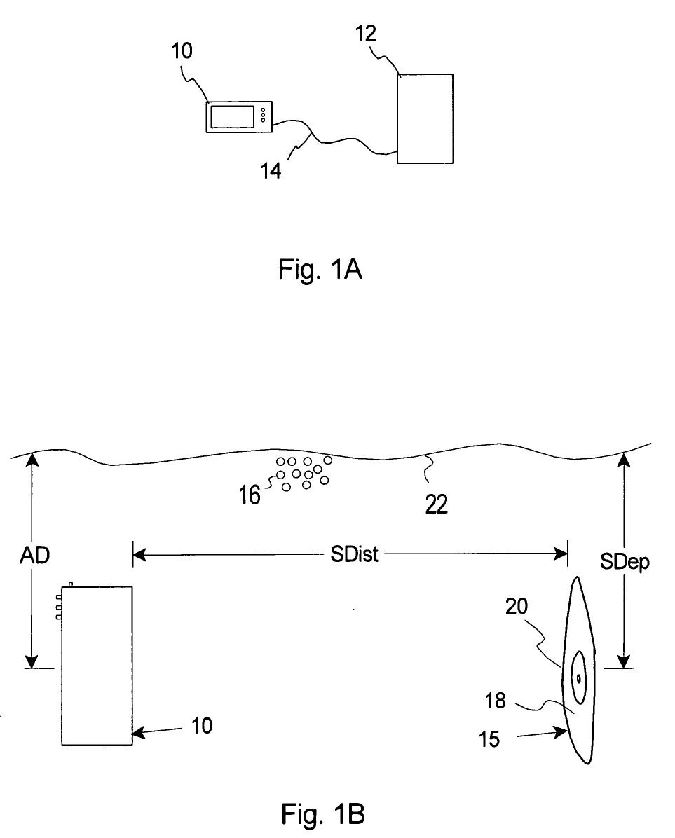

FIG. 1A is a simplified side plan illustration of a combination having features of the present invention, including an image capturing apparatus 10, and a color compensation system 12. In this embodiment, the image capturing apparatus 10 captures a captured image (not shown in FIG. 1A) and the color compensation system 12 can be used to adjust the color composition of the captured image and provide an adjusted image (not shown in FIG. 1A). As an overview, in certain embodiments, the color compensation system 12 can evaluate the color composition that is present in the originally captured image, calculate the amount of attenuation, and subsequently replace and/or enhance the colors that were attenuated in the captured image to generate the adjusted image which more accurately represents the actual color composition of a scene (not shown in FIG. 1A).

In FIG. 1A, an electrical connection line 14 can connect the image capturing apparatus 10 to the color compensation system 12 to allow for the transfer of one or more original captured images to the color compensation system 12. Alternatively, the original captured images can be transferred to the color compensation system 12 in another fashion. For example, the image capturing apparatus 10 can include a removable storage system (not shown in FIG. 1A) that is selectively removed from the image capturing apparatus 10 and inserted into a docking port (not shown) of the color compensation system 12. Still alternatively, the captured images can be transferred to the color compensation system 12 via the Internet.

FIG. 1B is a simplified side plan illustration of the image capturing apparatus 10 and a scene 15. The image capturing apparatus 10 is useful for capturing the original captured image (not shown in FIG. 1B) of the scene 15. The type of scene 15 captured by the image capturing apparatus 10 can vary. In certain embodiments, the image capturing apparatus 10 is waterproof and is adapted to capture images of one or more scenes 15 that are partly or fully under a fluid 16 (partly illustrated as a plurality of small circles), e.g. a liquid such as water. For example, each scene 15 can include one or more underwater animals, plants, mammals, fish, coral, objects, and/or environments. In FIG. 1B, the scene 15 includes a starfish 18 that is a subject 20, e.g. the focal point of the scene 15.

In certain embodiments, the image capturing apparatus 10 can be any device capable of capturing the original image, including (i) a digital camera that electronically stores the image, (ii) a digital camera in video mode, (iii) a conventional film type camera that records the scene 15 on a photosensitive film or plate, and/or (iv) a video recording device that electronically records still or moving images. As provided herein, in certain embodiments, the image capturing apparatus 10 includes one or more features that can provide information to the color compensation system 12 so that the color compensation system 12 can compensate for the attenuation and absorption of light in the water 16.

In FIG. 1B, the focal point 20 of the scene 15, e.g. the center of the starfish 18 is at a subject depth SDep below a fluid surface 22, and the image capturing apparatus 10 is at an apparatus depth AD below the fluid surface 22. For example, the subject depth SDep can be greater than, less than or approximately equal to the apparatus depth AD. Moreover, the subject 20 of the scene 15 is separated a separation distance SDist away from the image capturing apparatus 10.

FIG. 1C includes a first graph that illustrates the attenuation of light in a fluid (the ocean) in percent per meter as a function of wavelength and a second graph that illustrates the percentage of 465 nm light reaching certain depths. In these graphs, line I represents extremely pure ocean water; line II represents turbid tropical-subtropical water; line III represents mid-latitude water; and lines 1-9 represent coastal waters of increasing turbidity. The incidence angle is 90 degrees for lines I-III and the incidence angle is 45 degrees for lines 1-9. The graphs in FIG. 1C are reproduced from Jerlov N. G. 1976. Marine Optics. Amsterdam: Elsevier Scientific Publishing Company ISBN 0444414908.

As can be seen in FIG. 1C, attenuation of light is influenced by the type of fluid, the angle of incidence, the depth, and the turbidity. Further, the attenuation of light is also influenced by the wavelength of the light. For example, longer wavelength light is attenuated more rapidly then shorter wavelength light.

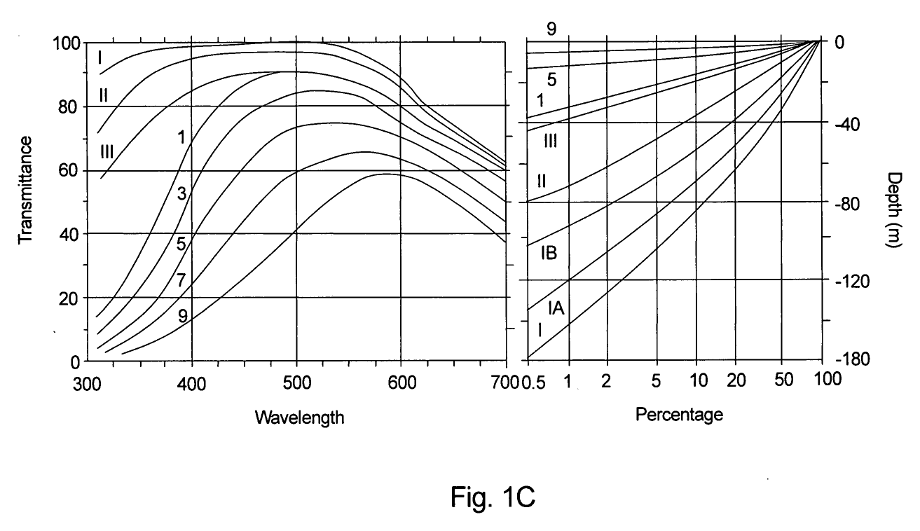

FIG. 2A illustrates a simplified, front perspective view of one, non-exclusive embodiment of the image capturing apparatus 210. In this embodiment, the image capturing apparatus 210 is a camera that includes an apparatus frame 224, an optical assembly 226, a capturing system 228 (illustrated as a box in phantom), a power source 230 (illustrated as a box in phantom), an illumination system 232, and a control system 234 (illustrated as a box in phantom). The design of these components can be varied to suit the design requirements and type of image capturing apparatus 210. Further, the image capturing apparatus 210 could be designed without one or more of these components. For example, the image capturing apparatus 210 could be designed without the illumination system 232.

The apparatus frame 224 can be rigid and support at least some of the other components of the image capturing apparatus 210. In one embodiment, the apparatus frame 224 includes a generally rectangular shaped hollow body that forms a cavity that receives and retains at least a portion of the capturing system

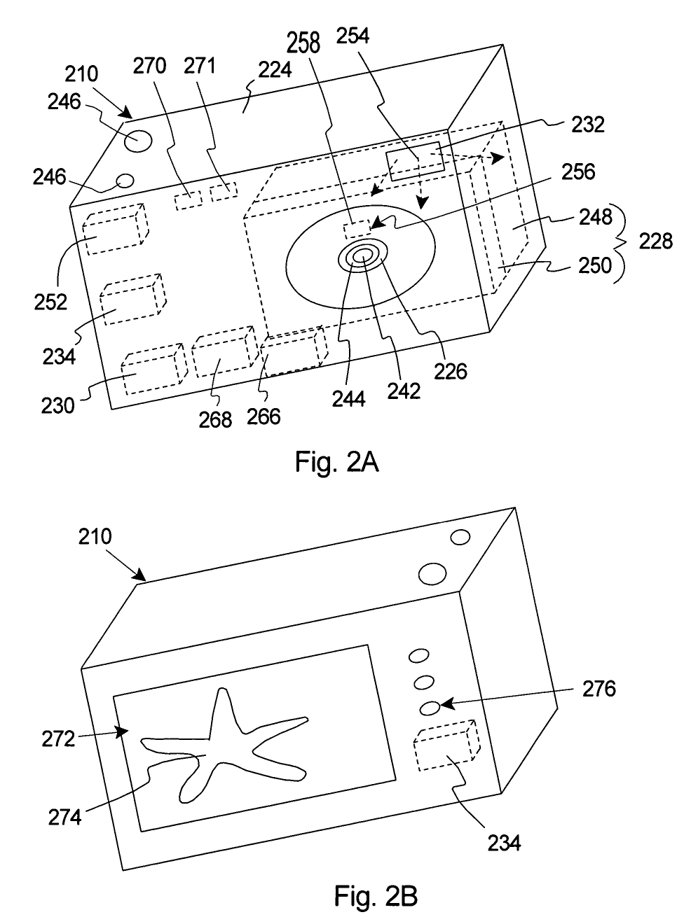

In one embodiment, apparatus frame 224 is watertight and forms a watertight compartment that protects the electronic components of the image capturing apparatus 210. Alternatively, as illustrated in FIG. 3 and described below, the image capturing apparatus 310 can include an inner apparatus frame 324 and an outer apparatus frame 338 that forms an outer shell that surrounds and encloses the inner apparatus frame 324 and that provides a watertight barrier around the electronic components of the image capturing apparatus 310.

Referring back to FIG. 2A, the apparatus frame 224 can include an aperture 242 and a shutter mechanism 244 that work together to control the amount of light that reaches the capturing system 228. The shutter mechanism 244 can include a pair of shutter shades that work in conjunction with each other to allow the light to be focused on the capturing system 228 for a certain amount of time. The shutter shades are activated by a shutter button 246.

The optical assembly 226 can include a single lens or a combination of lenses that work in conjunction with each other to focus light onto the capturing system 228.

The capturing system 228 captures the captured image (not shown in FIG. 2A). The design of the capturing system 228 can vary according to the type of image capturing apparatus 10. For example, for a conventional film type camera, the capturing system 228 includes a piece of film. In this design, light focused on the film causes a chemical reaction which results in the image being formed on the film. Alternatively, as illustrated in FIG. 2A, for a digital type camera, the capturing system 228 includes an image sensor 248 (illustrated in phantom), a filter assembly 250 (illustrated in phantom), and a storage system 252 (illustrated in phantom).

The image sensor 248 receives the light that passes through the aperture 242 and converts the light into electricity. One non-exclusive example of an image sensor 248 for digital cameras is known as a charge coupled device (“CCD”). An alternative image sensor 248 that may be employed in digital cameras uses complementary metal oxide semiconductor (“CMOS”) technology. CMOS devices use several transistors at each photosite to amplify and move the charge using more traditional wires.

The image sensor 248, by itself, produces a grayscale image as it only keeps track of the total intensity of the light that strikes the surface of the image sensor 248. Accordingly, in order to produce a full color image, the filter assembly 250 is necessary to capture the colors of the image.

It should be noted that other designs for the capturing system 228 can be utilized.

It should also be noted, as discussed in more detail below, that with information from the capturing system 228, the color compensation system 12 (illustrated in FIG. 1A) can compensate for the absorption of light in the fluid 16.

The storage system 252 stores the various captured images before the images are ultimately printed out, deleted, transferred or downloaded to the color compensation system 12, an auxiliary storage system or a printer. The storage system 252 can be fixedly or removable coupled to the apparatus frame 224. Non-exclusive examples of suitable storage systems 252 include flash memory, a floppy disk, a hard disk, or a writeable CD or DVD.

The power source 230 provides electrical power to the electrical components of the image capturing apparatus 210. For example, the power source 230 can include one or more chemical batteries, either the one time use disposable batteries (such as alkaline, zinc-air), or the multiple use rechargeable batteries (such as nickel-cadmium, nickel-metal-hydride, lead-acid, lithium-ion).

The illumination system 232 can provide a generated light beam 254 (illustrated as dashed arrows), e.g. a flash of light, that can be used to illuminate at least a portion of the scene 15.

In one embodiment, the imaging capturing apparatus 210 includes an autofocus assembly 256 including one or more lens movers 258 that move one or more lenses of the optical assembly 226 in or out until the sharpest possible image of the subject 20 is received by the capturing system 228. For example, the autofocus assembly 256 can be an active or passive type system.

With either autofocus system, the control system 234 can determine the separation distance SDist (illustrated in FIG. 1A) between the optical assembly 226 and the subject 20. The information relating to the separation distance SDist can be stored concurrently with the corresponding captured image in the storage system 252 for later processing with the color compensation system 12.

Alternately or additionally, the image capturing apparatus 210 can include a separate sensor (not shown) that determines the separation distance SDist between the image capturing apparatus 210 and the subject 20 of the scene 15. Still alternatively, as described in more detail below, the approximate separation distance SDist can be manually input in the image capturing apparatus 210 or the color compensation system 12 by the user.

In one embodiment, the image capturing apparatus 210 includes a clarity sensor 266 that measures some feature related to the clarity of the fluid 16 (illustrated in FIG. 1A) near the image capturing apparatus 210 prior to, during and/or after the captured image is captured with the capturing system 228. The clarity signal can be transferred to the storage system 252 along with the corresponding captured image for subsequent processing with the color compensation system 12.

The clarity of the fluid 16 shall mean and include any measure of the clearness of the fluid, including, but not limited to the turbidity, the visibility, and/or the optical quality of the fluid such as the reflectance or the transmittance of the fluid 16. For example, the clarity sensor 266 can be a turbidity sensor that measures the turbidity of the fluid 16. In another embodiment, the clarity sensor 266 can be an optical quality sensor that measures an optical quality of the fluid 16. For example, the optical quality sensor can be a transmittance sensor that measures relative light transmittance over a fixed distance in the fluid 16. As another example, the optical quality sensor can be a reflectance sensor that measures the reflectance of light by the fluid 16. Still, alternatively, the clarity sensor 266 can be another type of sensor.

In one embodiment, the clarity sensor 266 could transmit a limited number of discrete states of clarity in order to simplify processing. In alternative, non-exclusive embodiments, the clarity sensor 266 could transmit 5, 10, 15, 20, or 25 different levels of turbidity, transmittance, or reflectance.

In another embodiment, the clarity sensor 266 can include a wavelength attenuation sensor that measures absorption of single colors, e.g. red, blue, green, or white light. A sensor assembly that measures white light could include a red sensor that measures the amount of red, a green sensor that measures the amount of green, and a blue sensor that measures the amount of blue.

Additionally, the image capturing apparatus 210 can include an apparatus depth sensor 268 that measures the depth of a portion of the image capturing apparatus 210 under the fluid surface 22 (illustrated in FIG. 1B). For example, the depth sensor 268 can measure the depth of the image capturing apparatus 210 prior to, during and/or immediately after the image is captured with the capturing system 228. Further, the depth sensor 268 can provide an apparatus depth signal that is transferred to the storage system 252 along with the corresponding captured image for subsequent processing with the color compensation system 12. For example, the apparatus depth sensor 268 can be a pressure sensor that measures the pressure near the image capturing apparatus 210.

Moreover, the image capturing apparatus 210 can include a location sensor 270 that measures the approximate geographic location of the image capturing apparatus 210 prior to, during and/or immediately after the image is captured with the capturing system 228. Further, the location sensor 270 can provide an apparatus location signal that is transferred to the storage system 252 along with the corresponding captured image for subsequent processing with the color compensation system 12. For example, the location sensor 270 can be a global positioning system that measures the approximate location of the image capturing apparatus 210. The global positioning system can also provide time/date code information in the signal. Alternatively, the location sensor 270 can be another type of sensor.

In another embodiment, the image capturing apparatus 210 can include a time/date system 271 that monitors the approximate time and/or date prior to, during and/or immediately after the image is captured with the capturing system 228. Further, the time/date system 271 can provide a time/date signal that is transferred to the storage system 252 along with the corresponding captured image for subsequent processing with the color compensation system 12. For example, the time/date system 271 can include a digital timepiece that measures the approximate time of date and/or the date when the captured image is captured.

The control system 234 is electrically connected to and controls the operation of the electrical components of the image capturing apparatus 210. The control system 234 can include one or more processors and circuits and the control system 234 can be programmed to perform one or more of the functions described herein.

The control system 234 can cause the captured image, and one or more of (i) the related clarity of the fluid 16, (ii) the separation distance SDist, (iii) the apparatus depth AD, (iv) the subject depth SDep, (v) the approximate location, (vi) the time of day, and/or (vii) the date to be stored in the storage system 252 along with the corresponding captured image for subsequent processing with the color compensation system 12. It should be noted that one or more of these compensation factors can be manually input by the user into the control system 234 or the color compensation system 12 and/or measured by the image capturing apparatus 210.

In one embodiment, the control system 234 is coupled to the apparatus frame 224 and is positioned within the apparatus frame 224.

Referring to FIG. 2B, additionally, the image capturing apparatus 210 can include an image display 272 that displays the captured image 274 that is being captured. Additionally, the image display 272 can display other information such as the time of day, the date, the apparatus depth, the clarity, and/or the separation depth.

Moreover, the image capturing apparatus 210 can include one or more control switches 276 electrically connected to the control system 234 that allows the user to control the functions of the image capturing apparatus 210. For example, one or more of the control switches 276 can be used to manually input one or more of (i) the clarity, (ii) the separation distance, (iii) the apparatus depth, (iv) the subject depth, (v) the fluid type, (vi) the time of day, (vii) the date, (viii) the location, (ix) the angle of incidence of light, and/or (x) the weather.

Additionally, one or more of the control switches 276 can be used to selectively switch the image capturing apparatus 210 to an under liquid mode in which one or more of the sensors disclosed herein are activated.

FIG. 3 is a simplified side plan illustration of another embodiment of an image capturing apparatus 310 that includes an inner apparatus frame 324 and a selectively removable outer apparatus frame 338. In this embodiment, the inner apparatus frame 324 is somewhat similar to the corresponding apparatus frame 224 described above. However, in this embodiment, the inner apparatus frame 324 is not waterproof. Instead, in this embodiment, the outer apparatus frame 338 forms an outer shell that surrounds and encloses the inner apparatus frame 324 and provides a watertight barrier around the electronic components of the image capturing apparatus 310.

In one embodiment, the outer apparatus frame 338 is at least partly made of a clear material. Moreover, the outer apparatus frame 338 can include one or more pass through switches 380 that can be used to control the operation of the control switches 376 of the image capturing apparatus 310.

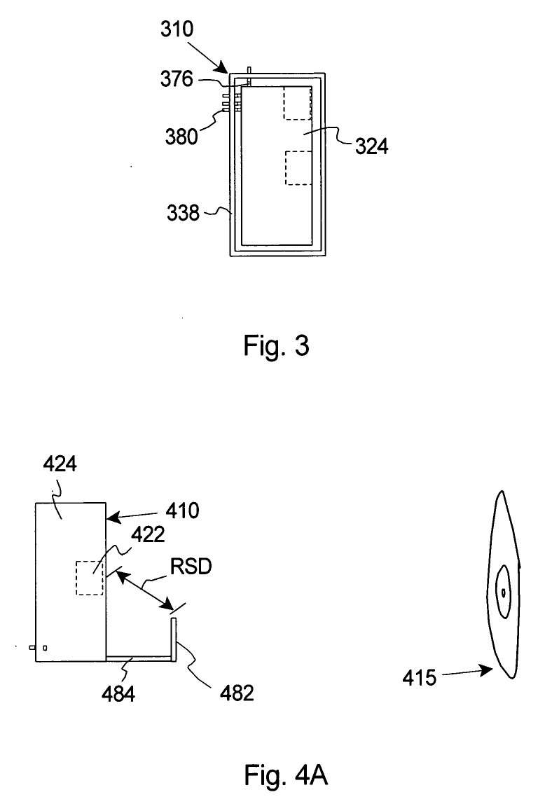

FIG. 4A is a simplified top plan illustration of a scene 415 and another embodiment of an image capturing apparatus 410 that includes an apparatus frame 424, a color reference 482 and a reference holder 484. In FIG. 4A, the reference holder 484 selectively secures the color reference 482 to the apparatus frame 424 with the color reference 482 spaced apart a know reference separation distance RSD from the optical assembly 426. Further, in one embodiment, the color reference 482 is positioned in a fashion that when the image capturing apparatus 410 captures the captured image 474, a portion of the color reference 482 is also captured in each captured image 474 (illustrated in FIG. 4B).

The design of the reference holder 484 and the color reference 482 can be varied to suit the design requirements of the image capturing apparatus 410. In FIG. 4A, the reference holder 484 is a rigid beam that extends between the color reference 482 and the apparatus frame 424. Further, the rigid beam can be selectively secured to each of the color reference 482 and the apparatus frame 424. With this design, the color reference 482 and the reference holder 484 can be removed during non-use and/or the image capturing apparatus 410 can be used without the color reference 482. Additionally, with this design, the color reference 482 and the reference holder 484 can be used above water for color compensation.

For example, the color reference 482 can be a generally flat sheet that is made of a material that is not significantly influenced by the fluid (not shown in FIG. 4A). For example, the color reference 482 can be made of plastic.

In one embodiment, the color reference 482 is positioned so that the color reference 482 is positioned in the lower right corner of the captured image 474 (illustrated in FIG. 4B). Alternatively, for example, the color reference 482 can be positioned so that the color reference 482 is alternatively located in the captured image 474.

FIG. 4B illustrates the rear view of the image capturing apparatus 410 of FIG. 4A, with the image display 472 displaying the captured image 474. More specifically, FIG. 4B illustrates that the captured image 474 includes a captured color reference image 486 of the color reference 486 (illustrated in FIG. 4A).

FIG. 4C illustrates a first, non-exclusive embodiment of a color reference 482C. In this embodiment, the color reference 482C is a white card that is the color white (represented by “W's”).

FIG. 4D illustrates another, non-exclusive embodiment of a color reference 482D. In this embodiment, the color reference 482D is a multi-spectral card that includes a plurality of different colored regions 488. In one non-exclusive example, one or more of the regions 488 can include the colors white (represented by “W's”), red (represented by “R's”), blue (represented by “B's”), and/or green (represented by “G's”). Alternatively, one or more of the regions 488 can be another color.

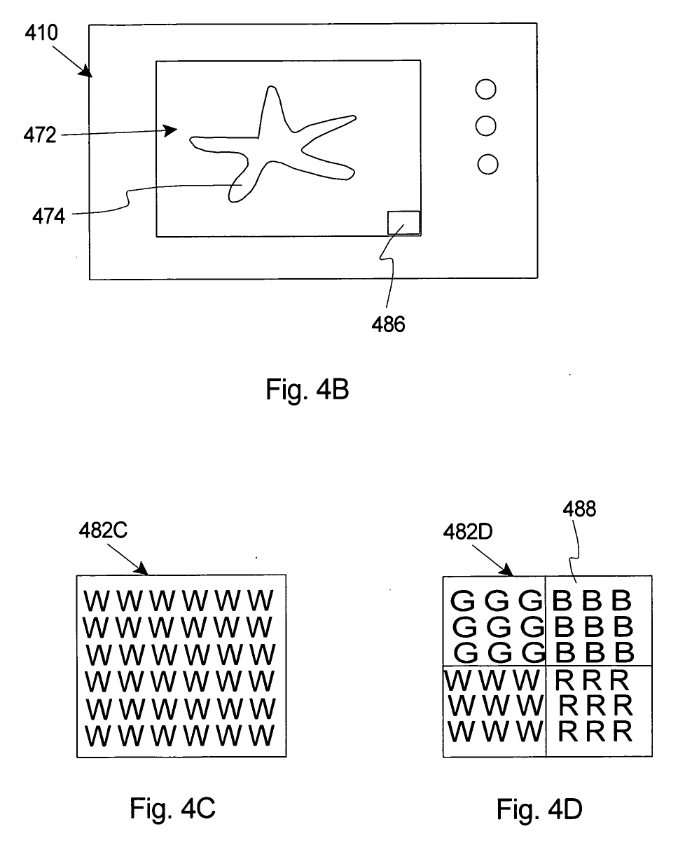

FIG. 5 illustrates a rear view of the image capturing apparatus 510 that illustrates how one or more of the compensation factors that influence the colors of the captured image (not shown in FIG. 5), such as a clarity of the fluid, the separation distance SDist, the apparatus depth AD, the subject depth SDep, the fluid type, the approximate location, the time of day, the date, the angle of incidence of light, and/or the weather can be manually input into the image capturing apparatus 510. In this embodiment, the user can manually input one or more of these factors into the image capturing apparatus 510A. Subsequently, one or more of these compensation factors can be transferred to the color compensation system (not shown in FIG. 5) along with the captured images for subsequent color compensation.

In FIG. 5, the image display 572 displays the factors of (i) a clarity of the fluid, (ii) the separation distance SDist, (iii) the apparatus depth AD, (iv) the subject depth SDep, (v) the fluid type, (vi) the approximate location, (vii) the time of day, (viii) the date, (ix) angle of incidence, and (ix) the weather. With this design, the user can use one or more of the control switches 576 to move a cursor to select one or more of these compensation factors and input data relating to these compensation factors. The selection can be made prior, during, or after the snorkel or dive.

For example, if the clarity is selected, the user can manually input the approximate clarity. In one embodiment, the image display 572 could display a limited number of different clarity levels (not shown) that are commonly experienced during snorkeling and/or scuba diving. For example, the image display 572 could list eight different clarity levels, namely clarifies 1 through 8. As non-exclusive examples, the clarity levels could correspond to different levels of visibility, different levels of turbidity, different levels of transmittance or different levels of reflectance.

If separation distance is selected, the image display 572 could display a limited number of different separation distances SDist.

If the apparatus depth is selected, different apparatus depth ranges that are commonly experienced during snorkeling and/or scuba diving could be displayed. For example, four different apparatus depth ranges, namely (i) underwater range 1—used for snorkeling (average compensation 20 feet); (ii) underwater range 2—shallow SCUBA (average compensation 50 Feet); (iii) underwater range 3—medium depth SCUBA (average compensation 70 Feet); and (iv) underwater range 4—Deep depth SCUBA (average compensation 100 Feet). Alternatively, a limited number of different apparatus depths could be displayed.

If subject depth SDep is selected, the image display 572 could display a limited number of different subject depths SDep.

If fluid type is selected, the user can manually input a fluid type. In one embodiment, the image display 572 could display a limited number of different fluid types. For example, the image display 572 could display the choice of fresh water and salt water. Alternatively, other fluid type choices could be available.

If the location is selected, the image display 572 could display a number of different popular dive and snorkel locations or dive sites. With this design, the user can select the appropriate location.

If time of day is selected, the user can manually input the approximate time of day that the captured image is captured. Somewhat similarly, if the date is selected, the user can manually input the date that the captured image is captured. With information regarding the time of day, the date, and the location, angle of daylight penetration into the fluid can be calculated. Alternatively, the user can manually enter an approximate angle of incidence of the light on the fluid.

If the weather is selected, the user can manually input a weather type that the image capturing apparatus 510 will be utilized within. In one embodiment, the image display 580 could display a limited number of different weather types, e.g. sunny, cloudy, partly cloudy, overcast, or raining.

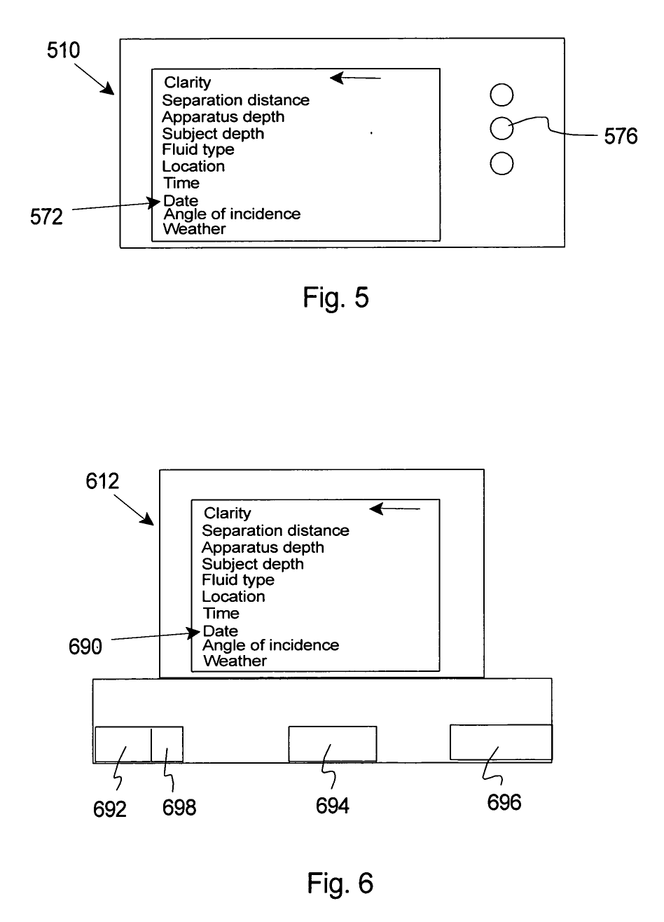

FIG. 6 illustrates one embodiment of a color compensation system 612 having features of the present invention. In this embodiment, the color compensation system 612 adjusts the color composition of the captured image (not shown in FIG. 6) to provide an adjusted image (not shown in FIG. 6). The design of the color compensation system 612 can be varied.

In FIG. 6, the color compensation system 612 is a personal computer that includes a system display 690, a system storage device 692, a system processor 694, a system input device 696, and compensation software 698. For example, (i) the system display 690 can be a monitor, (ii) the system storage device 692 can include one or more magnetic disk drives, magnetic tape drives, optical storage units, CD-ROM drives and/or flash memory, (iii) the system processor 694 can include one or more conventional CPU's, and (iv) the system input device 696 can include a keyboard, or a mouse.

In FIG. 6, the system display 690 displays the compensation factors of (i) a clarity of the fluid, (ii) the separation distance SDist, (iii) the apparatus depth AD, (iv) the subject depth SDep, (v) the fluid type, (vi) the approximate location, (vii) the time of day, (viii) the date, (ix) the angle of incidence, and (x) the weather. Each of these compensation factors can be used to determine the amount of light attenuated by the fluid (not shown in FIG. 6) and to determine the amount of color compensation is necessary for the captured image.

With this design, the user can use the system input device 696 to select one or more of the compensation factors and input data relating to these compensation factors. One or more of these compensation factors can be entered into the color compensation system 612 in a somewhat similar fashion as described above in the discussion of FIG. 5. Alternatively, one or more of these compensation factors can be transferred to the color compensation system 612 concurrently with the captured images from the image capturing system (not shown in FIG. 6).

The compensation software 698 utilizes one or more algorithms to perform color compensation on one or more of the captured images. In one embodiment, the color compensation software can utilize empirical data (such as the chart in FIG. 1C), as well as one or more of the compensation factors to perform color compensation on the captured images. With this design, the compensation software 698 evaluates the colors of the originally captured image and compensates for the absorption of light (lost colors) in the fluid so that the adjusted image more accurately represents the true colors of the scene. Stated in another fashion, the compensation software 698 can provide amplification and can restore the actual colors to the adjusted image.

In certain embodiments, the compensation software 698 adjusts a color content of the captured image to achieve the adjusted image based one or more of the following compensation factors (i) the clarity of the fluid, (ii) the separation distance SDist, (iii) the apparatus depth AD, (iv) the subject depth SDep, (v) the fluid type, (vi) the approximate location, (vii) the time of day, (viii) the date, (ix) an angle of incidence, and (ix) the weather. For example, the compensation software 698 can adjust the color content of the captured image based on any one or any combination of the compensation factors described herein. In one embodiment, the compensation software 698 utilizes only one of the compensation factors to adjust the color content of the captured image. In other embodiments, for example, the compensation software 698 uses 2, 3, 4, 5, 6, 7, 8, 9 or all 10 of the compensation factors to create a more complex color adjustment profile.

In one embodiment, the compensation software 698 causes the compensation system 612 to evaluate the color content that is present in an originally captured image. The compensation software 698 can subsequently replace and/or enhance the colors that were attenuated and generate the adjusted image which more accurately represents the actual color composition of the scene. For example, if the compensation software 698 determines that the subject contains a red region, the compensation software 698 can calculate an approximate attenuation of the red light on the subject 20 based on one or more of the compensation factors. The amount of attenuation and/or absorption of light can be calculated with the compensation software 698 using information from graphs that are somewhat similar to the graphs illustrated in FIG. 1C or other sources. With information regarding the attenuation, the compensation software 698 can provide reverse attenuation of the red, e.g add red to the initial captured image so that the adjusted image more accurately represents the actual colors of the scene.

As utilized herein, the terms “actual colors” or “true colors” shall mean the colors that are present with no light attenuation at the scene and the scene is illuminated with an even white light.

The compensation software 698 can perform a similar function for each of the other colors in the captured image. Thus, the compensation software 698 adjusts the captured image by adjusting the intensity of the red, green and blue color values in the captured image. Blue is significantly attenuated, green has medium attenuation and red has high amplification. As a result thereof, in one embodiment, the compensation software 698 can adjust the color compensation of the captured image by adding more red than green or blue. With this design, the compensation software 698 can provide reverse compensation and replace the colors of the scene that are lost due to attenuation.

It should be noted that the user can manually adjust the values of one or more of compensation factors in the color compensation system 612 on a continuous scale to suit the preferences of the user of the color compensation system 612 to achieve the desired color composition of the adjusted image.

In one embodiment, captured images captured at approximately the same depths, separation distances, conditions, turbidity, location, date, and/or time could then be batch processed to correct colors.

In another embodiment, if the captured image includes a captured color reference image, or a natural object of known color (e.g. white), the compensation software 698 can evaluate the captured color reference image and can adjust the color composition of the captured image so that an adjusted color reference image in the adjusted image (not shown in FIG. 6) has the correct color composition. With this design, the compensation software 698 has a color reference to adjust the captured image to provide the adjusted image. Stated in another fashion, if a white card, or a multi-spectral card, is captured in the captured image, the compensation software 698 can use this information to make more precise adjustments of color content of the adjusted image. In certain embodiments, this could allow for very accurate color adjustment by the compensation software 698. Additionally, one or more of the compensation factors can be used concurrently with the color reference to provide more accurate color compensation.

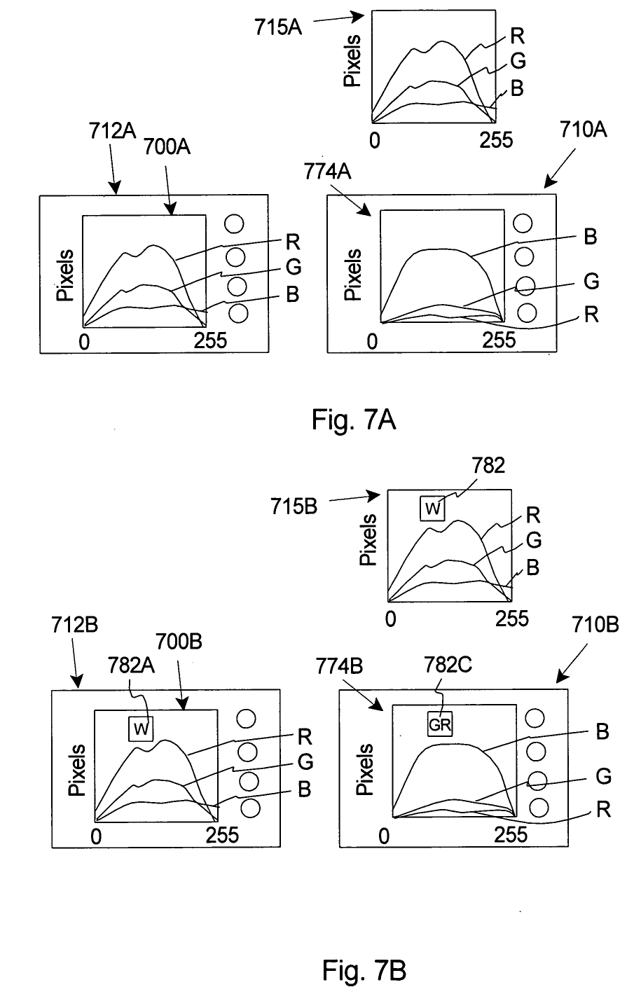

FIG. 7A is a simplified illustration of a RGB histogram of the actual colors of a scene 715A within a fluid (not shown), a simplified view of a RGB histogram of an unadjusted, originally captured image 774A of the scene 715A displayed on an image capturing apparatus 710A, and a RGB histogram of an adjusted image 700A of the scene 715A on a color compensation system 712A. In the RGB histograms, line designated “R” represents red, line designated “G” represents green, line designated “B” represents blue, and the level of R, G, and B is expressed as a number between 0 and 255. The vertical axis is the relative number of pixels that have each value of R, G, B. For example, the higher the position of the curve, the higher number of pixels that have that particular value of R, G, B.

FIG. 7A illustrates that the RGB histogram of the unadjusted captured image 774A that is originally captured by the image capturing apparatus 710 without any color compensation by the image capturing apparatus 710 is very different from the RGB histogram of the original scene 715A. More specifically, some of the red R and green G from the scene has been lost. This difference is caused by the attenuation of light in the fluid. As a result thereof, the originally captured image 774A does not accurately represent the actual colors of the scene.

The RGB histogram of the adjusted captured image 700A is the color profile of the adjusted capture image 700A that is adjusted by the color compensation system 712A with the compensation software (not shown in FIG. 7A) as described above. More specifically, using one or more of the compensation factors described above, the compensation software has estimated the amount of light that was attenuation. In certain embodiments, as the number of compensation factors utilized is increased, the accuracy of the compensation is increased. As is illustrated in FIG. 7A, the color compensation system 712A has accurately compensated for the attenuation of light. As a result thereof, the RGB histogram of the adjusted image 700A more accurately represents the actual colors of the scene 715A.

FIG. 7B is a simplified illustration of a RGB histogram of the actual colors of the scene 715B within a fluid (not shown), a simplified view of a RGB histogram of an unadjusted, originally captured image 774B of the scene 715B displayed on an image capturing apparatus 710B, and a RGB histogram of an adjusted image 700B of the scene 715B on a color compensation system 712B. In the RGB histograms, line designated “R” represents red, line designated “G” represents green, line designated “B” represents blue, and the level of R, G, and B is expressed as a number between 0 and 255.

The scene 715B is similar to the scene 715A illustrated in FIG. 7A. However, the scene 715B includes a color reference 782, namely a white card that is positioned in the scene 715B. The color reference 782 is represented as a square in the RGB histograms. The letter “W” represents the color white of the color reference in the scene 715B.

FIG. 7B illustrates that the RGB histogram of the unadjusted captured image 774B that is originally captured by the image capturing apparatus 710B without any color compensation by the image capturing apparatus 710B is very different from the RGB histogram of the original scene 715B. This difference is caused by the attenuation of light in the fluid. As a result thereof, the originally captured image 774B does not accurately represent the true colors of the scene. More specifically, some of the red R and green G from the scene 715B are actually represented in the unadjusted captured image 774B as blue B. Further, a captured color reference image 782C within the captured image 774B does not appear white. More specifically, because of the uneven attenuation of different wavelengths of light, the captured color reference image 782C appears grey (represented as “GR”).

The RGB histogram of the adjusted captured image 700B is the color profile of the adjusted capture image 700B that is adjusted by the color compensation system 712B with the compensation software (not shown in FIG. 7B) as described above. More specifically, in one embodiment, the compensation software can calculate the amount of light attenuated utilizing (i) information regarding the color of the color reference 782, (ii) the distance between the color reference 782 and the optical assembly (not shown) of the image capturing apparatus 710B, and (iii) the captured color reference image 782C in the captured image 774B. For example, if the color reference 782 is at a first distance from the optical assembly and the subject is at a second distance from the optical assembly, then the compensation software can calculate or estimate the additional wavelength absorption or amplification based on the difference of distance between the color reference 782 and the subject. Subsequently, the compensation software can adjust the colors in the entire captured image 774B to provide the adjusted image 700B.

As is illustrated in FIG. 7B, the color compensation system 712B has accurately compensated for the attenuation of light. As a result thereof, the RGB histogram of the adjusted image 700B more accurately represents the true colors of the scene 715B. Further, an adjusted color reference image 782A is white (represented as “W”) and accurately represents the color composition of the color reference 782 placed in the scene 715B. In certain embodiments, the color compensation system 712B adjusts the color composition of the entire captured image 774B so that the color composition of the adjusted color reference image 782A is approximately the same and closely matches the color composition of the color reference 782. Stated in another fashion, the color compensation system 712B adjusts the color composition of the entire captured image 774B so that the color composition of the adjusted color reference image 782A is closer than the color composition of the captured color reference image 782C to the color composition of the color reference 782.

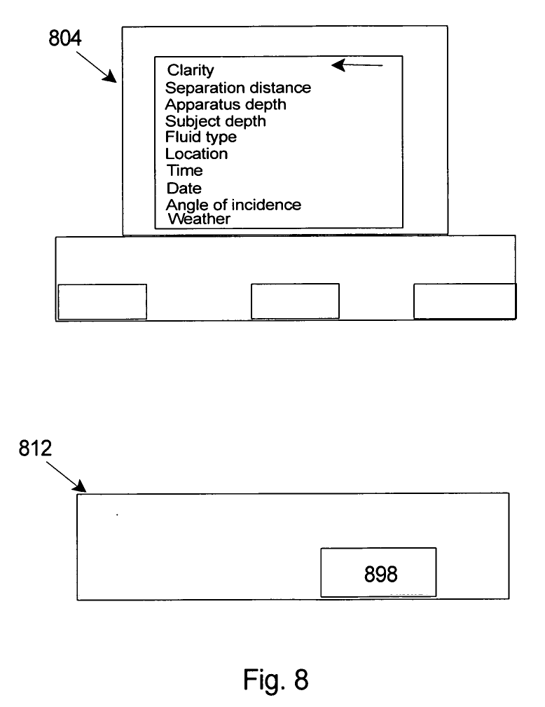

FIG. 8 is a simplified illustration of yet another embodiment of a color compensation system 812 having features of the present invention. In this embodiment, the color compensation system 812 is again a computer system that contains the compensation software 898. However, in this embodiment, the color compensation system 812 is remotely accessed by a personal computer 804 over the internet. With this design, the captured image and one or more of the compensation factors can be transferred to the color compensation system 812. Subsequently, the color compensation system 812 can provide the adjusted image. Alternatively, if the scene (not shown in FIG. 8) includes a color reference (not shown in FIG. 8), the color compensation system 812 provides the adjusted image based on the captured color reference image within the captured image.

While the current invention is disclosed in detail herein, it is to be understood that it is merely illustrative of the presently preferred embodiments of the invention and that no limitations are intended to the details of construction or design herein shown other than as described in the appended claims.

What is claimed is:

1. A compensation system for adjusting a captured image of a scene that is within a fluid, the captured image being captured by an image capturing apparatus, the compensation system comprising:
a compensation software that adjusts the captured image based on information regarding at least one of a plurality of compensation factors, the compensation factors comprising (i) a clarity of the fluid, (ii) a fluid type of the fluid, (iii) an approximate time of day the captured image is captured, (iv) an approximate geographic location in which the captured image is captured, (v) an approximate date in which the captured image is captured, (vi) an angle of incidence of light at the time the captured image is captured, and (vii) an approximate weather in which the captured image is captured.

2. The compensation system of claim 1 wherein the compensation software utilizes the information regarding at least one of the plurality of compensation factors to calculate an attenuation of light, and the compensation software adjusts the color composition of the captured image based on the calculated attenuation of light.

3. The compensation system of claim 1 wherein the compensation software adjusts the captured image based on information regarding at least two of the compensation factors.

4. The compensation system of claim 1 wherein the compensation software adjusts the captured image based on information regarding at least three of the compensation factors.

5. The compensation system of claim 1 wherein the compensation software adjusts the captured image based on information regarding at least four of the compensation factors.

6. The compensation system of claim 1 further comprising a system input device that allows a user to input information regarding at least one of the compensation factors.

7. The compensation system of claim 1 further comprising a system input device that allows a user to adjust the information regarding at least one of the compensation factors.

8. A combination comprising an image capturing apparatus and the compensation system of claim 1.

9. The combination of claim 8 wherein the image capturing apparatus measures at least one of the compensation factors.

10. The combination of claim 8 wherein the image capturing apparatus includes a control switch that allows a user to input information regarding at least one of the compensation factors.

11. A compensation system for adjusting a captured image of a scene that is within a fluid, the captured image being captured by an image capturing apparatus, the compensation system comprising:
a compensation software that adjusts the captured image based on information regarding at least one of a plurality of compensation factors, the compensation factors comprising (i) a clarity of the fluid, (ii) an apparatus depth of the image capturing apparatus, (iii) a separation distance between the image capturing apparatus and a subject of the scene, (iv) a fluid type of the fluid, (v) a subject depth of the subject, (vi) an approximate time of day the captured image is captured, (vii) an approximate geographic location in which the captured image is captured, (viii) an approximate date in which the captured image is captured, (ix) an angle of incidence of light at the time the captured image is captured, and (x) an approximate weather in which the captured image is captured; and
a system input device that allows a user to input information regarding at least one of the compensation factors.

12. The compensation system of claim 11 wherein the compensation software utilizes the information regarding at least one of the plurality of compensation factors to calculate an attenuation of light, and the compensation software adjusts the color composition of the captured image based on the calculated attenuation of light.

13. The compensation system of claim 11 wherein the compensation software adjusts the captured image based on information regarding at least four of the compensation factors.

14. The compensation system of claim 11 wherein the system input device allows the user to adjust the information regarding at least one of the compensation factors.

15. A combination comprising an image capturing apparatus and the compensation system of claim 11.

16. The combination of claim 15 wherein the image capturing apparatus includes a control switch that allows a user to input information regarding at least one of the compensation factors.

17. A compensation system for adjusting a captured image of a scene that is within a fluid, the captured image being captured by an image capturing apparatus, the compensation system comprising:
a compensation software that adjusts the captured image based on information regarding at least one of a plurality of compensation factors, the compensation factors comprising (i) a clarity of the fluid, (ii) an apparatus depth of the image capturing apparatus, (iii) a separation distance between the image capturing apparatus and a subject of the scene, (iv) a fluid type of the fluid, (v) a subject depth of the subject, (vi) an approximate time of day the captured image is captured, (vii) an approximate geographic location in which the captured image is captured, (viii) an approximate date in which the captured image is captured, (ix) an angle of incidence of light at the time the captured image is captured, and (x) an approximate weather in which the captured image is captured; and
a system input device that allows a user to adjust the information regarding at least one of the compensation factors.

18. The compensation system of claim 17 wherein the compensation software utilizes the information regarding at least one of the plurality of compensation factors to calculate an attenuation of light, and the compensation software adjusts the color composition of the captured image based on the calculated attenuation of light.

19. The compensation system of claim 17 wherein the compensation software adjusts the captured image based on information regarding at least four of the compensation factors.

20. A combination comprising an image capturing apparatus and the compensation system of claim 17.

21. The combination of claim 20 wherein the image capturing apparatus includes a control switch that allows a user to input information regarding at least one of the compensation factors.

22. A compensation system for adjusting a captured image of a scene that is within a fluid, the scene including a color reference, the captured image being captured by an image capturing apparatus, the captured image including a captured color reference image of the color reference, the compensation system comprising:
a compensation software that adjusts a color composition of the captured image based on a color composition of the captured color reference image within the captured image and a color composition of the color reference, wherein the compensation software calculates an attenuation of at least one wavelength of light based on the difference between the color composition of the color reference and the color composition of the captured color reference image, and wherein the compensation software adjusts a color composition of the captured image to provide an adjusted image having an adjusted color reference image that is similar in color to the color reference.

23. The compensation system of claim 22 wherein the compensation software adjusts the color composition of the captured image based on the calculated attenuation of a plurality of wavelengths of light.

24. The compensation system of claim 22 wherein the compensation software adjusts the captured image based on information regarding at least one of a plurality of compensation factors, the compensation factors comprising (i) a clarity of the fluid, (ii) a fluid type of the fluid, (iii) an approximate time of day the captured image is captured, (iv) an approximate geographic location in which the captured image is captured, (v) an approximate date in which the captured image is captured, (vi) an angle of incidence of light at the time the captured image is captured, and (vii) an approximate weather in which the captured image is captured.

25. A combination comprising the compensation system of claim 22, an image capturing apparatus, and a color reference that is coupled to the image capturing apparatus.

26. A combination comprising:
an image capturing apparatus for capturing a captured image of a scene that is within a fluid, the image capturing apparatus including an apparatus frame and a color reference that is selectively attached to the apparatus frame, the captured image including a captured color reference image of the color reference; and
a compensation software that adjusts a color composition of the captured image based on a color composition of the captured color reference image within the captured image and a color composition of the color reference, wherein the compensation software calculates an attenuation of at least one wavelength of light based on the difference between the color composition of the color reference and the color composition of the captured color reference image.

27. The combination of claim 26 wherein the color reference is a white card.

28. The combination of claim 26 wherein the color reference is a multi-spectral card.

29. A combination for capturing an image of a scene, the combination comprising:
an image capturing apparatus that is adapted to capture a captured image of the scene; and
a color reference that is selectively secured to the image capturing apparatus in a fashion so that the color reference appears in the captured image.

30. The combination of claim 29 wherein the color reference is a white card.

31. The combination of claim 29 wherein the color reference is a multi-spectral card.

32. A method for adjusting a captured image of a scene that is within a fluid, the captured image being captured by an image capturing apparatus, the method comprising the step of:
adjusting the captured image with a compensation system based on information regarding at least one of a plurality of compensation factors, the compensation factors comprising (i) a clarity of the fluid, (ii) a fluid type of the fluid, (iii) an approximate time of day the captured image is captured, (iv) an approximate geographic location in which the captured image is captured, (v) an approximate date in which the captured image is captured, (vi) an angle of incidence of light at the time the captured image is captured, and (vii) an approximate weather in which the captured image is captured.

33. The method of claim 32 wherein the step of adjusting includes the step of calculating an attenuation of light based on at least one of the compensation factors.

34. The method of claim 32 further comprising the step of inputting at least one of the compensation factors into the compensation system.

35. A method for adjusting a captured image of a scene that is within a fluid, the scene including a color reference, the captured image being captured by an image capturing apparatus, the captured image including a captured color reference image of the color reference, the method comprising the step of: adjusting a color composition of the captured image with a compensation system to provide an adjusted image having an adjusted color reference image that is similar in color to the color reference.
